(19) United States
(12) Patent Application Publication
(10) Pub. No.: US 2003/0180697 A1
(43) Pub. Date: Sep. 25, 2003

(54) Multi-degree of freedom telerobotic system for micro assembly

(76) Inventors: Kyung Hwan Kim, Seoul (KR); Deok Ho Kim, Seoul (KR)

Correspondence Address: HARNESS, DICKEY & PIERCE, P.L.C., P.O. BOX 828, BLOOMFIELD HILLS, MI, 48303, US

(21) Appl. No.: 10/245,067

(22) Filed: Sep. 17, 2002

(30) Foreign Application Priority Data
Mar. 22, 2002 (KR) 2002-15679

(51) Int. Cl. G09B 19/00

(52) U.S. Cl. 434/219; 434/307 R; 434/365

(57) ABSTRACT

The present invention relates to a multi-degree of freedom telerobotic system. More particularly, the invention relates to a telerobotic system for micro assembly operation through remote control that teaches the movement of a robot by extracting the multi-degree movement information of a human operator and transferring the information to the multi-degree of freedom telerobot through a network.

The multi-degree of freedom telerobotic system comprises a multi-degree of freedom teaching means for converting the information extracted from human operator concerning the movement of multi-degree of freedom joints into electrical signals, a processing means for transmitting the extracted multi-degree of freedom movement information to a robot through a network, a micro robot control means for converting the multi-degree of freedom movement information into control signals, a micro vision and a graphic image generation means for providing an effective visual information of micro parts assembly environment, overlaying the virtual images graphic image generation means as virtual images.

### BACKGROUND OF THE INVENTION

The present invention relates to a multi-degree of freedom telerobotic system. More particularly, the invention relates to a telerobotic system for micro assembly operations through remote control that teaches the movement of a robot by extracting the multi-degree movement information of a human operator and transferring the information to the multi-degree of freedom telerobot through a network.

In contrast to the conventional mechanical systems which mainly operate in one particular work area, the future development will be concentrated on developing mechanical systems that can operate in a micro scale or nano-scale task. The present researches on the micro system are limited to unit parts such as micro operators and micro sensors using Micro Electro Mechanical System (MEMS). However, the micro products will require an assembly of these unit parts in the future. The assembly of a micro product with complex structure requires a human manipulation technology that can operate in a micro area.

The assembly of micro parts in the precision of a few micro meter becomes possible through a multidegree of freedom telerobotic system for micro assembly by reducing the movement and force of a human operator's finger into a scale of one to few thousands or one to few ten thousands. The application areas of the multi-degree of freedom telerobotic system for micro assembly are as follows.

1) Communication/Precision machines Area: Various IT communication devices and precision machines which are ultra small in size and utilize mechatronics technology with a high degree of precision.

2) Medical Devices Area: Medical systems that can reduce the pain during a high precision surgery, artificial organ transplant, diagnostic and therapy.

3) Biotechnology Area: Cell manipulation, Reproduction of Genes

4) Micro Assembly Area: Ultra small precision motor and manufacturing system for producing small devices.

The ultra small and high performance micro systems such as above are essentially a composite assembly of MEMS and small precision parts. Such systems can be obtained by applying a human operator assembling capability to micro assembly through a multi-degree of freedom telerobotic system.

The conventional micro assembly lacks agility in operation since it is very much depended upon the dexterity of trained technicians and utilizes robots with limited degree of freedom. The present invention overcomes the limitation in the freedom of assembly for the conventional robots with the simple route teaching through the complex teaching capability.

The conventional micro assembly methods are either carried out manually thorough the hands of trained human operator while viewing through a microscope or through dedicated assembly apparatus such as a specially devised tweezers. Such methods have a low success rate in the assembly of micro parts, low precision and also time consuming.

Hence, these methods are not suitable for mass production of micro parts and also can not cope with the assembly when a variety of different micro parts are involved.

### SUMMARY OF THE INVENTION

The present invention is designed to overcome the above problems of prior art. The object of the invention is to provide a multi-degree of freedom telerobotic system which can maximize the efficiency of assembly operations, reduce the fatigue of human operators and can apply to various types of assembly operations.

The multi-degree of freedom telerobotic system according to the present invention comprises a multi-degree of freedom teaching means for converting the information extracted from human operator concerning the movement of multi-degree of freedom joints into electrical signals, a processing means for transmitting the extracted multi-degree of freedom movement information to a robot through a network, a micro robot control means for converting the converted multi-degree of freedom movement information into control signals, a multi-degree of freedom micro robot operation means for operating according to the converted multi-degree of freedom movement information, a micro vision means for providing an effective visual information of micro parts assembly environment, a graphic image generation means for converting the multi-degree of freedom movement information which was transmitted from the remote control processing means into graphic images and an image display means for displaying the visual information of micro parts assembly environment as a real image and for displaying the graphic images from the virtual images graphic image generation means as virtual images

### BRIEF DESCRIPTION OF THE DRAWINGS

FIG. 1 is a conceptual diagram of the multi-degree of freedom remotely controlled robot for micro assembly according to the present invention.

FIG. 2 shows the construction of a multi-degree of freedom remote control system according to the present invention.

FIG. 3 shows a brief construction of micro vision apparatus as shown in FIG. 2.

FIG. 4 shows the data transmission process diagram and flow chart for the multi-degree of freedom remote control.

### DETAILED DESCRIPTION OF THE EMBODIMENTS

Hereinafter, preferred embodiments of the present invention will be described in detail with reference to the accompanying drawings.

The present invention provides a multi-degree of freedom remotely controlled micro robot that can assist operators to carry out their manufacturing tasks such as micro assembly operation in comfort. The multi-degree of freedom remotely controlled micro robot is an important tool which connects the micro world with its operator. It can effectively transfer the multi-degree of freedom movement information of an operator to the micro robot and at the same time feedback the sensor information (location, force, vision) to the operator.

According to the constituents and control types of the multi-degree of freedom remotely controlled micro robot, its degree of freedom, precision and control performance are determined. In order for a successful micro assembly of micro parts, the development of high performance remote piloting technology for micro manipulation in a micro mechanics environment is required.

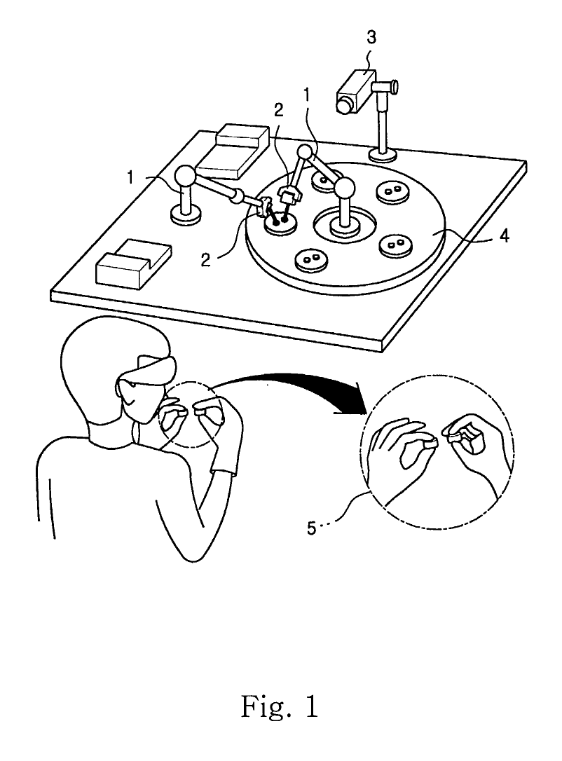

FIG. 1 is a conceptual diagram of the multi-degree of freedom remotely controlled robot for micro assembly according to the present invention.

As shown in FIG. 1, by providing a magnified visual image of micro parts to be assembled by the robot through a vision apparatus and at the same time, by transferring the teaching information of multi-degree of freedom movement extracted to the micro robots, micro parts can be manipulated as if through the fingers of a human operator.

Moreover, it further comprises a multi-degree of freedom remote teaching apparatus which provides counter feeling so that the operator can feel the touching sensation.

The present invention comprises a robot 1, micro gripper 2, vision system 3, part supplier 4, and multi-degree of freedom teaching apparatus 5. A complex teaching is possible by extracting the multi-degree of freedom movement of a human operator and a multi-degree of freedom micro assembly is possible by remotely controlling a robot which operates in a micro area with a high precision.

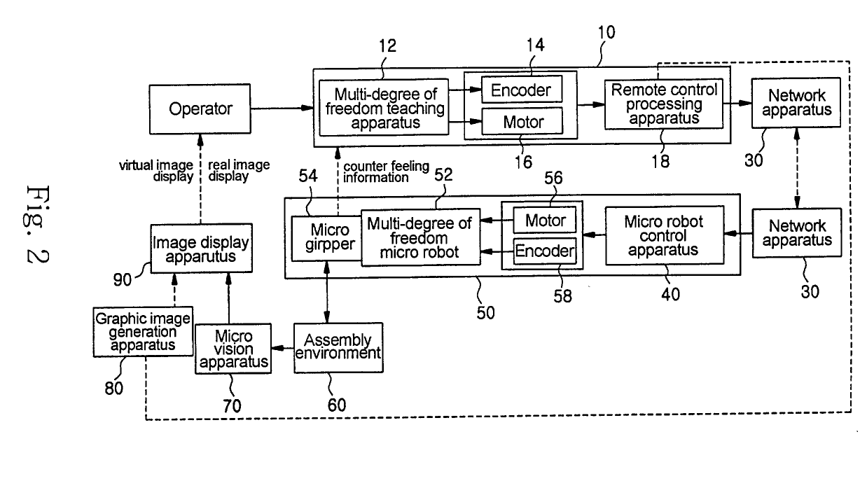

FIG. 2 shows the construction of a multi-degree of freedom remote control system according to the present invention.

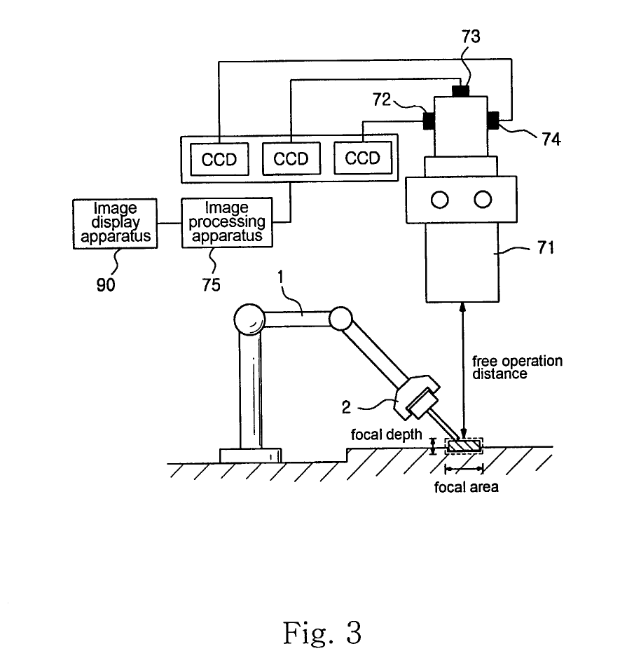

FIG. 3 shows a brief construction of micro vision apparatus as shown in FIG. 2.

The multi-degree of freedom remotely controlled robot for micro assembly which is capable of assembling 3 dimensional micro parts as shown in FIG. 2, comprises a multi-degree of freedom teaching means 10, which further comprises a multi-degree of freedom teaching apparatus 12 for converting the multi-degree of freedom movement information extracted from the hands movement of a human operator into electrical signals 12, and a remote control processing apparatus 20 for transmitting said extracted multi-degree of freedom movement information to a robot through a network 30; a micro robot operation means 50 which further comprises a micro robot control apparatus 40 for converting the multi-degree of freedom movement information received from said multi-degree of freedom teaching means 10 into control signals and a multi-degree of freedom micro robot 52 for operating according to said multi-degree of freedom movement information; a micro vision apparatus 70 for providing an effective visual information of micro parts assembly environment 60; a graphic image generation apparatus 80 for converting said multi-degree of freedom movement information which was transmitted from said remote control processing apparatus 20 into graphic images; an image display apparatus 90 for displaying the visual information of micro parts assembly environment from said micro vision apparatus 80 as a real image and for displaying the graphic images from said graphic image generation apparatus 80 as virtual images.

The multi-degree of freedom teaching means 10 further comprises a encoder 14 and motor 16 for converting the electric signals from the multi-degree of freedom teaching apparatus 12 into data signals.

The multi-degree of freedom teaching apparatus 12 has a counter feeling provision which provides force information to the operators generated during micro parts assembly.

The micro robot operation means 50, by comprising a micro gripper 54 which acts as a pair of tweezers, a motor 56 for operation and an encoder 58 for data conversion, can operate the multi-degree of freedom micro robot 52 according to the multi-degree of freedom movement information transmitted from the micro robot control apparatus 40.

The micro vision apparatus 70 adopts a microscope type which is superior in recognizing the shape of 3 dimensional micro parts and the specification for field of view is many time better than the conventional microscopes. Moreover, it provides multiple amplification information and at the same time, the provision and selection of multiple number of field of view are possible.

The micro vision apparatus 70 as shown in FIG. 3, comprises a microscope 71, 3 CCD cameras 72, 73, 74 and an image processing apparatus 75. The graphic images outputted from a plurality of CCD camera 72, 73, 74 located on the microscope 71 are transfer to the operator through the image processing apparatus 75 and image displaying apparatus 90.

In this case, the performance of the micro vision apparatus 70 is determined by the assembly operation speed and precision carried out by the multi-degree of freedom remote control. In order for a successful micro assembly operation, it is important to recognize 3 dimensional micro parts which has a high width to length ratio through a proper construction of the vision system. Also, the feedback location control information of the micro robot should be created through the vision recognition.

Hence, for the 3 dimensional micro assembly based on a remote control platform, it is very important to eradicate the problems occurring from the conventional micro remote control system and thus able to feedback al the necessary visual information to the operator.

The image display apparatus 90 monitors the assembly environment of the micro vision apparatus 70 and controls the scaling for remote control of a slave micro manipulator. It provides the location and angle information of the image processing apparatus 75 and manages the network. Also, it is possible to visualize the movement of the micro manipulator and to select the view point.

One side of image display apparatus 90 which is constructed for the multi-degree of freedom remote control system for micro assembly has a graphic model of a multi-degree of freedom robot and operates in real time by receiving the multi-degree of freedom location information from the operator. On the other side, real images of the multi-degree of freedom robot and gripper which are operated by the multi-degree of freedom teaching apparatus.

The functions of the multi-degree of freedom remote control system for micro assembly according to the present invention are as follows.

By viewing the visual information of the multi-degree of freedom robot and gripper displayed on the image display apparatus 90 through the micro vision apparatus 70, the operator can perform multi-degree of freedom assembly tasks using the multi-degree of freedom teaching apparatus 12.

The graphic images outputted from a plurality of CCD camera 72, 73, 74 located on the micro vision apparatus 70 which is superior in recognizing the shape of 3 dimensional micro parts are transfer to the graphic image generation apparatus 80 through the image processing apparatus 75.

At this instance, the processed vision image information is not only provided to the operator along with Graphic User Interface but also used as a sensing signal for the multi-degree of freedom micro robot feedback control.

The multi-degree of freedom movement information detected by the multi-degree of freedom teaching apparatus 12 is transferred to the multi-degree of freedom micro robot 52 through the TCP/IP network apparatus 30.

The functions of the remote control processing apparatus 20 include control functions of the multi-degree of freedom teaching apparatus, the multi-degree of freedom micro robot and gripper, vision image processing and Graphic User Interface.

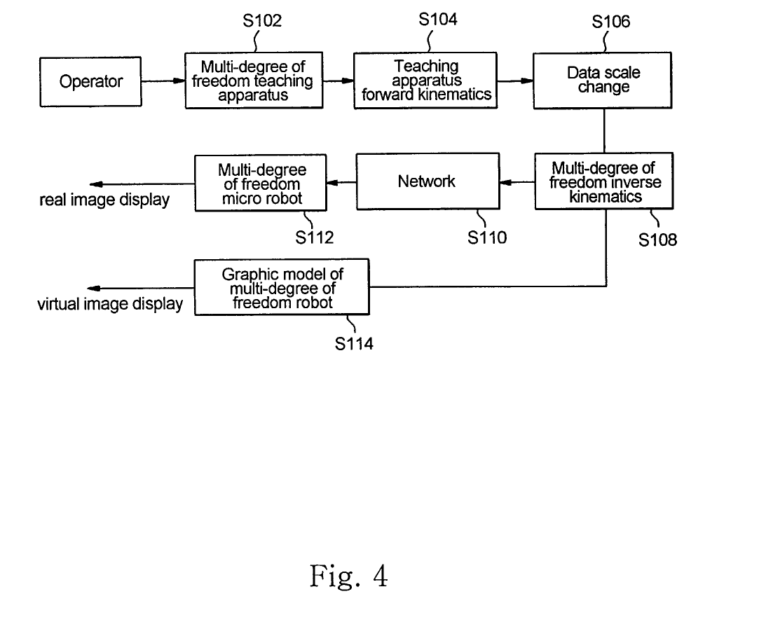

The data transmission process of the multi-degree of freedom remote control as shown in FIG. 4, after the multi-degree of freedom movement information of the human operator is extracted by the multi-degree of freedom teaching apparatus 12 (S102), it goes through forward kinematics of the teaching apparatus which represents the orthogonal coordinates and direction angle of the work table in terms of movement variables (S104).

In that state, the scale of the multi-degree of freedom movement information data are changed (S106) and goes through inverse kinematics of the multi-degree of freedom robot so that the variables are represented by the orthogonal coordinates and direction angle terms of the work table and transmitted via the network apparatus 30 (S110).

Afterwards, the multi-degree of freedom micro robot 52 is remote controlled according to the multi-degree of freedom movement information via the network apparatus 30 and also the visual information of the work area is displayed as a real image through the micro vision apparatus 70 (S112).

At this instance, after going through inverse kinematics of the multi-degree of freedom robot (S108), the graphic image created by the graphic image generation apparatus 80 through a multi-degree of freedom robot graphic model is displayed as a virtual image (S114).

The multi-degree of freedom telerobotic system for micro assembly according to the present invention can be used in micro-system assembly and apparatus thereof for various communication devices and precision machines which are small in size and have a high degree of precision.

Also, the present invention provides a multi-degree of freedom operation information for micro assembly through a multi-degree of freedom teaching apparatus. The present invention capable of assisting a human operator by providing a feedback information concerning the visual and tactile information generated during a micro assembly task.

Also, by maximizing the advantages of having a high quality force/vision information and extracting the multi-degree of freedom operation information, it can be utilized as a multi-degree of freedom micro assembly and apparatus thereof for mass production of MEMS and optical fiber parts.

What is claimed is:

1. A multi-degree of freedom telerobotic system for micro assembly, comprising:
a multi-degree of freedom teaching means for converting the information extracted from human operator concerning the movement of multi-degree of freedom joints into electrical signals;
a micro robot control means for converting said converted multi-degree of freedom movement information into control signals;
a micro vision means for providing an effective visual information of micro parts assembly environment;
a graphic image generation means for converting said multi-degree of freedom movement information which was transmitted from said remote control processing means into graphic images; and
an image display means for displaying said visual information of micro parts assembly environment as a real image and for displaying the graphic images from said virtual images graphic image generation means as virtual images.

2. The system as claimed in claim 1 wherein said multi-degree of freedom remote teaching apparatus providing a counter feeling function in order to convey the force information generated during micro assembly to an operator.

3. The system as claimed in claim 1 wherein said micro vision means further comprising a microscope for recognizing 3 dimensional micro parts which has a high width to length ratio and at least 3 CCD camera on one side for providing graphic images to the operator through an image display apparatus via an image processing apparatus.

4. The system as claimed in claim 1 wherein one side of said image display means has a virtual image of the graphic model of a multi-degree of freedom robot and on the other side of said image display means has a real images of the multi-degree of freedom robot and gripper which are operated by the multi-degree of freedom teaching means.
